(19) United States
(12) Patent Application Publication
(10) Pub. No.: US 2018/0354394 A1
(43) Pub. Date: Dec. 13, 2018

(54) Baby Slider

(71) Applicants: Israel Travieso, Brooklyn, NY (US); Ralph Horowitz, Massapequa, NY (US)

(72) Inventors: Israel Travieso, Brooklyn, NY (US); Ralph Horowitz, Massapequa, NY (US)

(21) Appl. No.: 15/932,898

(22) Filed: May 18, 2018

Related U.S. Application Data
(60) Provisional application No. 62/603,668, filed on Jun. 9, 2017.

(51) Int. Cl. B60N 2/28

(52) U.S. Cl. CPC B60N 2/2887; B60N 2/2803; B60N 2/2821

(57) ABSTRACT

An in-vehicle carriage with the capability of carrying and supporting a child in a child seat of a vehicle across the length of a plurality of transverse rods while supported securely by the same and further supported by side posts on the rear seat of a vehicle. Said carriage can be slid within the vehicle to the safe side of the vehicle, that being the sidewalk side of the vehicle regardless of which side of the street the vehicle is parked. In a lateral motion the carriage can be pulled by side straps, by rope or by remote control.

### FIELD OF THE INVENTION

This invention relates to safety, the safe boarding of children into and out of a vehicle, particularly from the sidewalk side of a vehicle. Such method of embarkation and disembarkation reduces injuries to both child and assisting adult.

### BACKGROUND OF THE INVENTION

While much emphasis has been given to children's safety in a vehicle, so much so, that it is the law to place children in a child seat or be penalized for not doing so. The present invention takes safety to a new and higher level when embarking and disembarking in and out of a vehicle.

Currently, an adult placing a child in a vehicle disregards the side of the street the child seat may be located. If the seat is positioned on the traffic side of the vehicle when parked, the adult due to being in a rush and tedious task of unstrapping and re-strapping the child seat from the traffic side of the vehicle to the sidewalk side, puts the child and the adult in danger. This invention reduces not only the labor involved in boarding and removing a child from a vehicle, but more importantly reduces and eliminates the danger involved. Currently the danger involved is obvious and therefore, a new method is called for. The invention allows the adult to safely place or remove a child from a vehicle safely with very little effort.

The new and safer method employs the use of a plurality of transverse rods, a carriage, and supporting side posts. The transverse rods, while supporting the carriage, rest against the rear seat of a vehicle. While suspended to the rear seat, the carriage attached to the transverse rods can be slid laterally, right to left, vice versa within the width of the vehicle. The lateral motion is accomplished by a rope/cord, push or pull or by remote control from the sidewalk side of the vehicle away from traffic. This child seat carrying carriage allows the adult to assist the child safely and effortlessly, regardless of the side of the street the vehicle is parked. When the vehicle is parked, if the child is on the traffic side of the vehicle, the adult (within the vehicle) can simply rope, pull/push or remotely slide the child towards the sidewalk side—danger and hassle free.

### SUMMARY OF THE INVENTION

A new and safer method of placing and removing a child from a vehicle from the sidewalk side of the vehicle. This new and much needed method reduces danger to both the child and the assisting adult. This method further reduces time while boarding or removing the child.

### BRIEF DESCRIPTION OF DRAWINGS

FIG. 1—Is an overview of the related invention

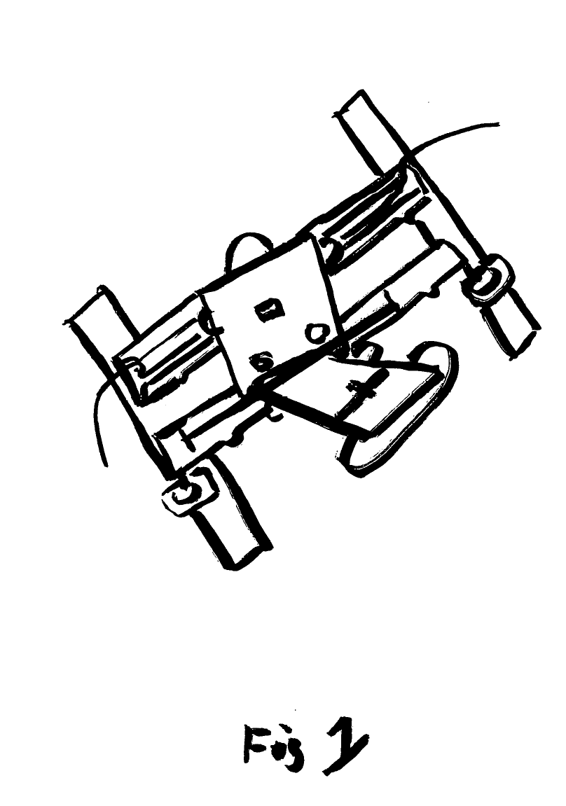

FIG. 2—Depicts seat base of the carriage with special features. Base 1, a seatbelt 2, to secure the child and child seat and a frontal strap 3, to harness around the vehicles' frontal car seat, side pull straps 4a and 4b on both sides of the carriage base.

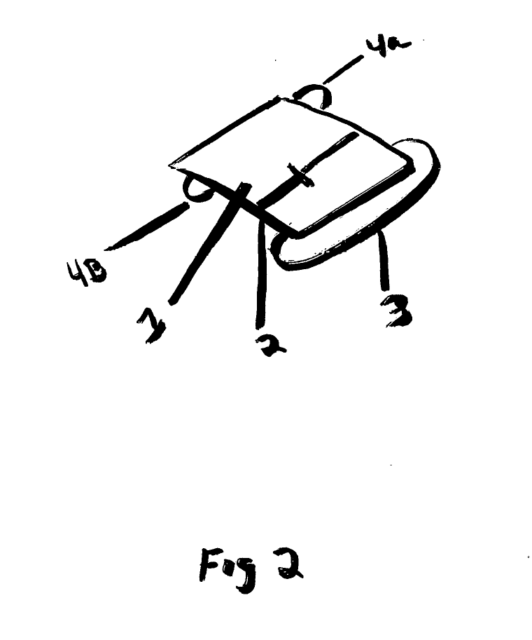

FIG. 3—Shows a shaft 5, along the length of the rear of carriage base, shaft couples base to carriage lower backrest, while allowing both to pivot against and away from each other while retaining ends 6a and 6b prevent shaft fallout.

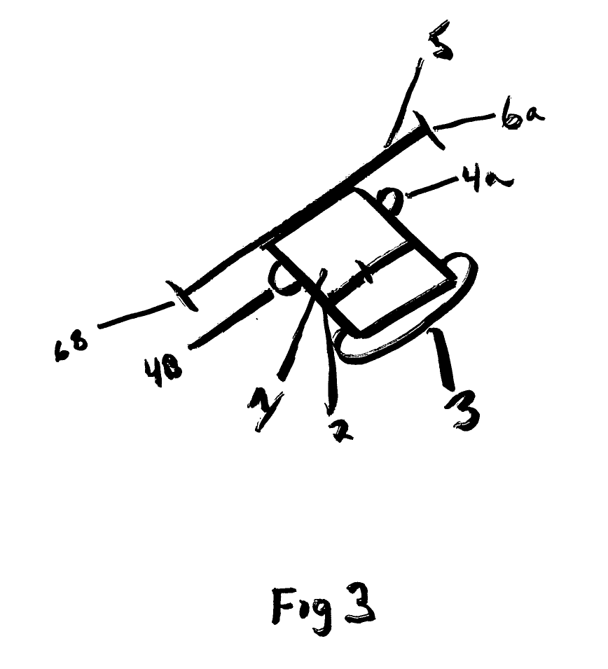

FIG. 4—Demonstrates hinges 7a and 7b, support and lock the carriage backrest and its base into an open L-shape position.

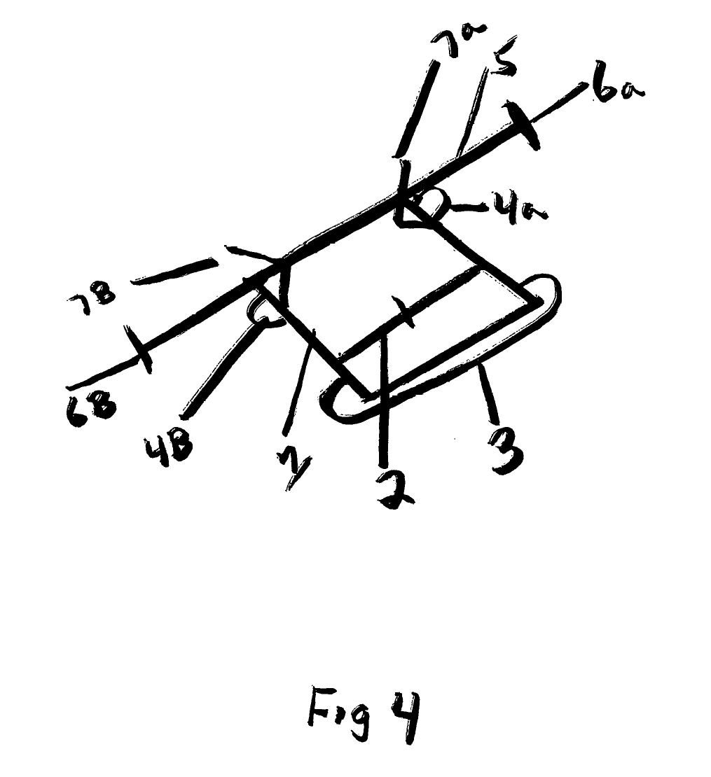

FIG. 5—Depicts the carriage backrest 8.

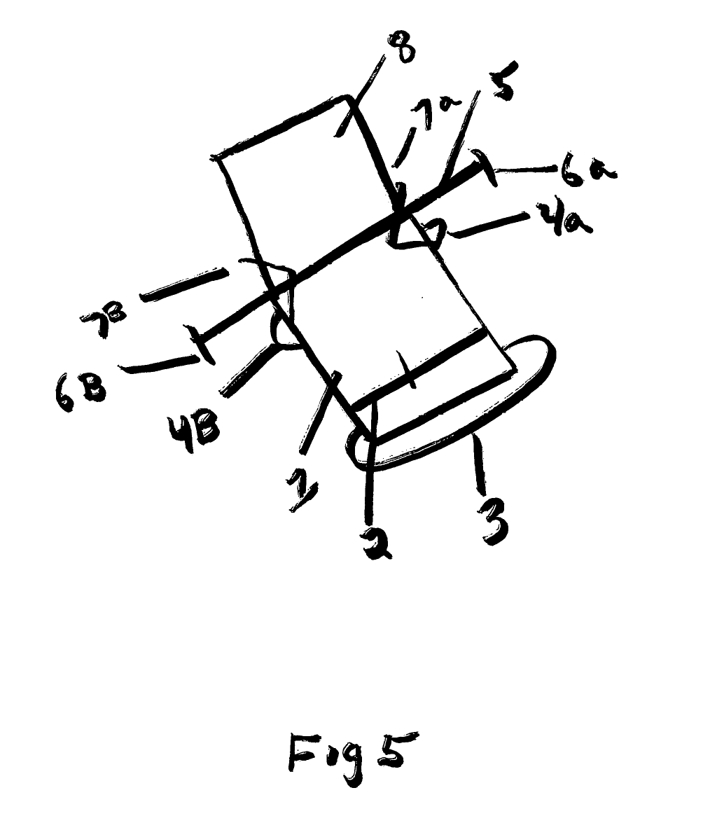

FIG. 6—Shows backrest with a wheel 9, at its lower portion to support the carriage transition over the vehicles' seat base.

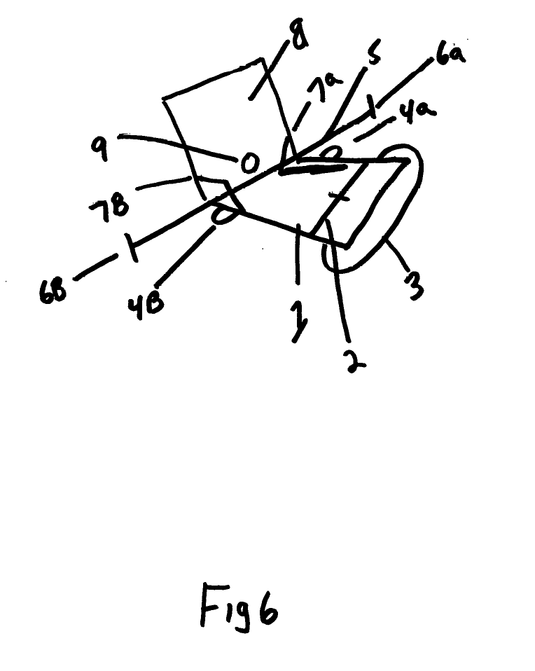

FIG. 7—Shows two pull straps 10a and 10b, one on each side of carriage backrest which in conjunction carriage base straps allow the carriage as a whole to be pulled towards the desired side of a vehicle.

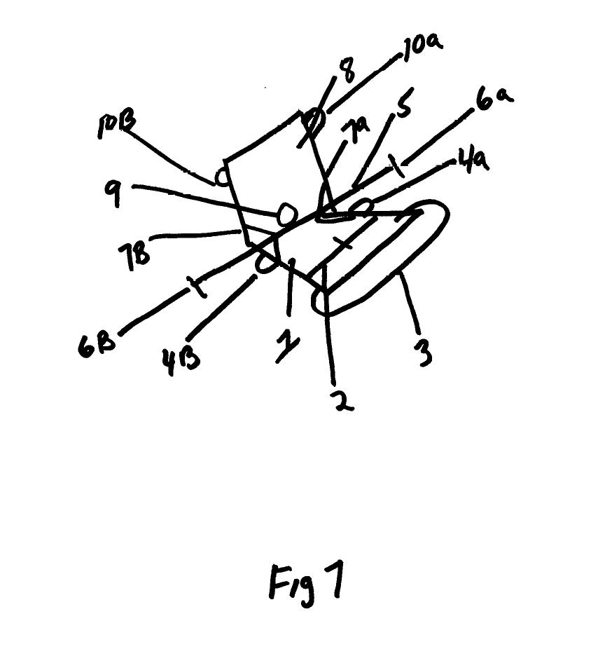

FIG. 8—A depiction of the carriage backrest harness 11, for securement around vehicles' headrest.

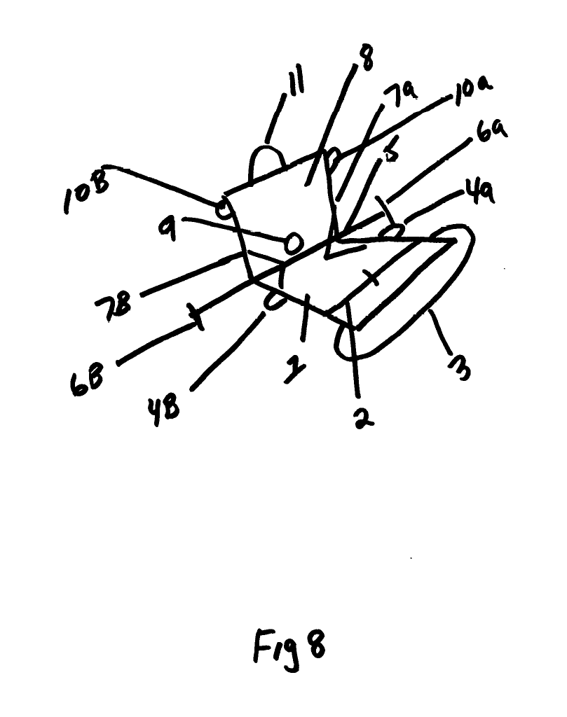

FIG. 9—Shows front view of penetrating tubes plate 12a and 12b on carriage backrest.

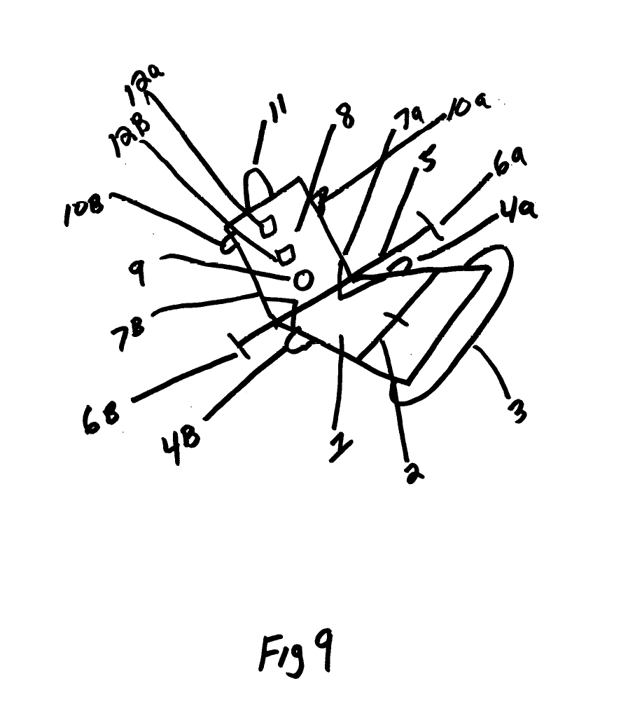

FIG. 10—Shows one of a plurality of transverse rods 13, along with right side safety self-locking slots 14.

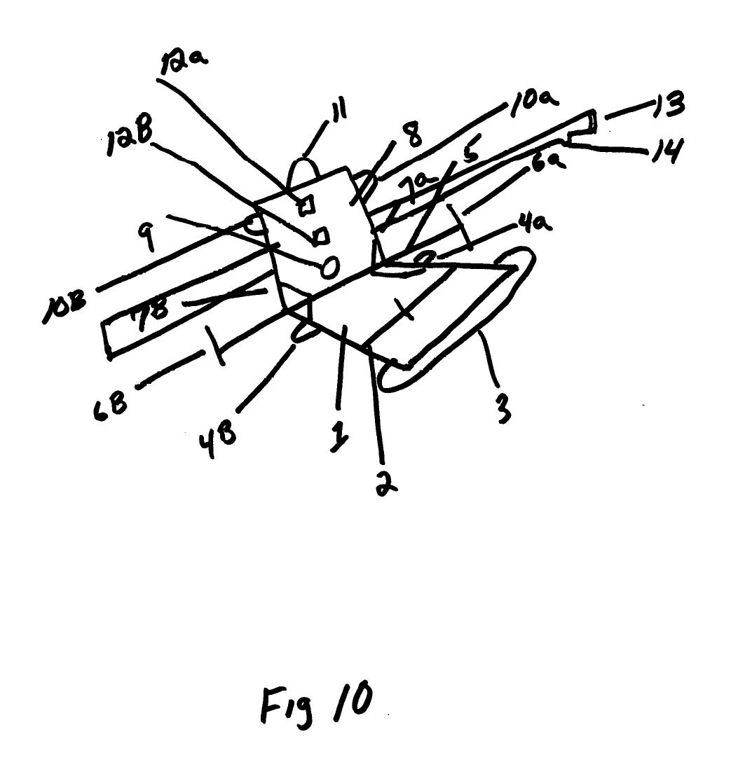

FIG. 11—Shows upper transverse rod 15 which together other transverse rod support and allow said carriage to move side to side, upper transverse rod safety self-locking slot 16 and transverse rod extension 17.

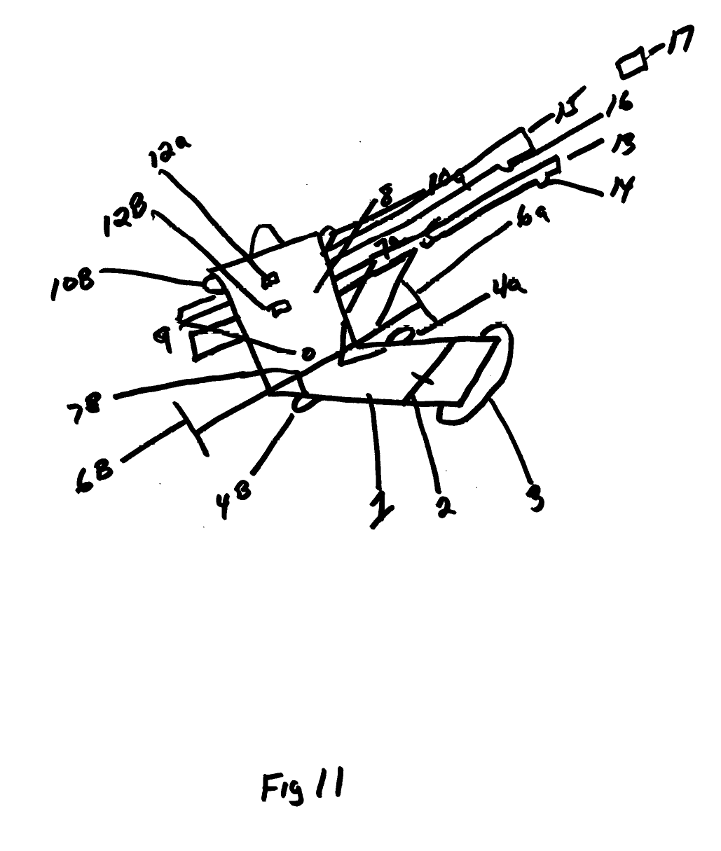

FIG. 12—Depicts upper transverse rod harness 18a and 18b to harness around the vehicles' headrest.

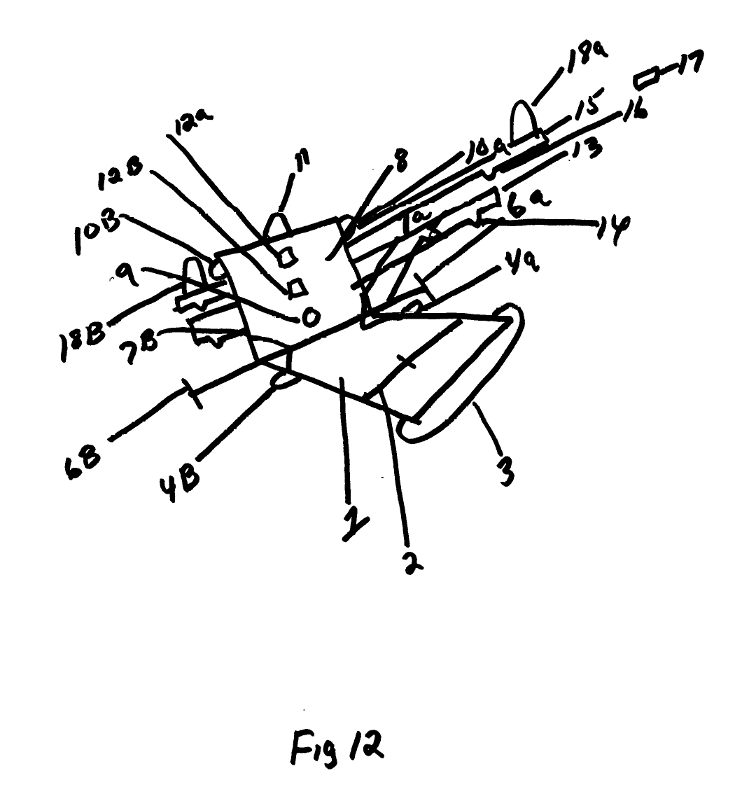

FIG. 13—Depicts transverse rods end nipples 19a and 19b.

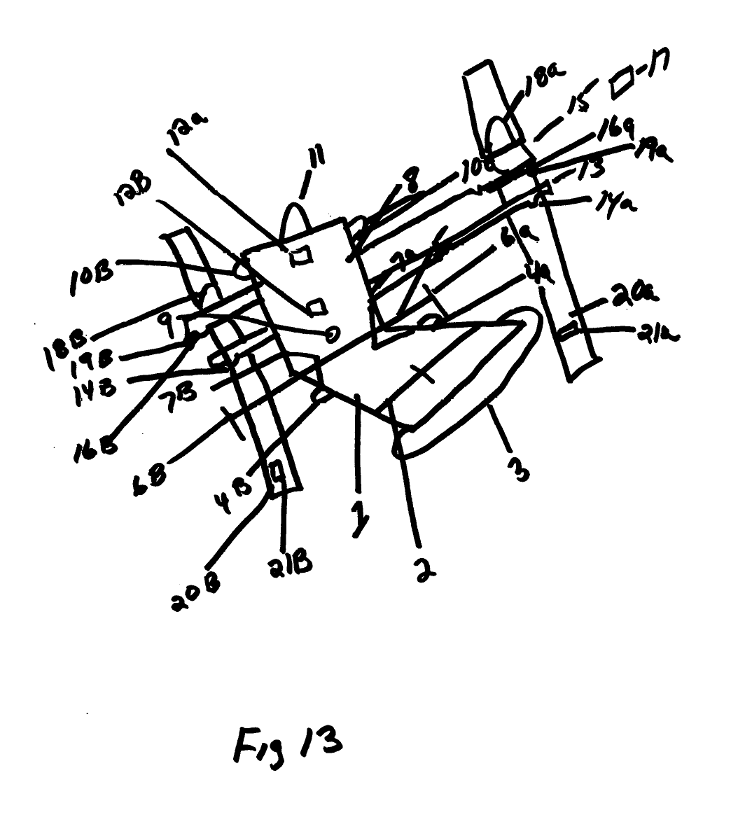

FIG. 14—Illustrates a slider in transverse rod interior.

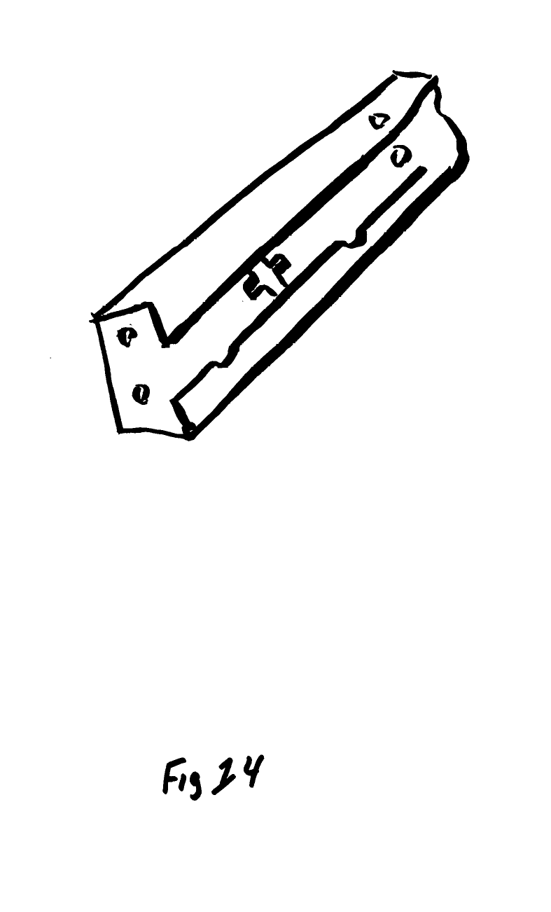

FIG. 15—Illustrates pull cord routing around transverse rods end rollers.

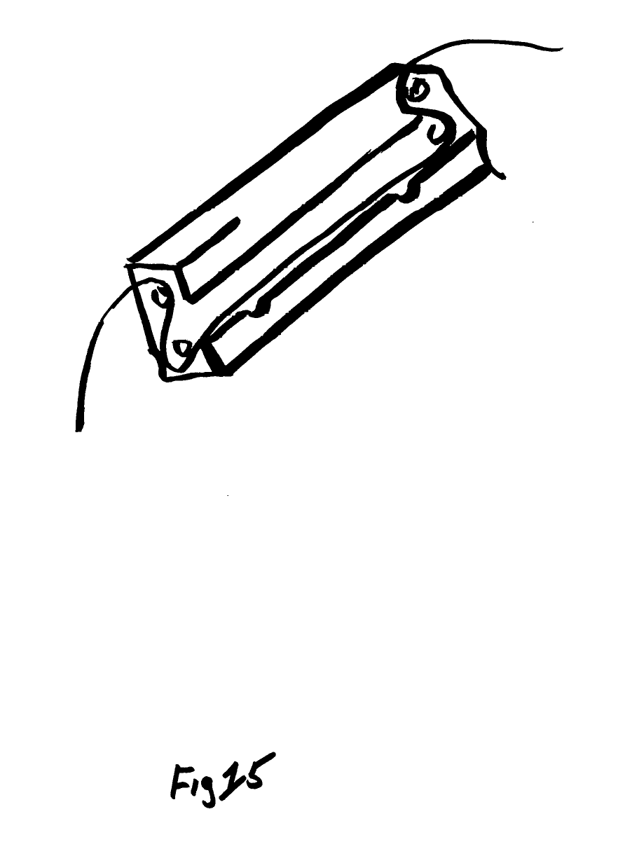

FIG. 16—Shows pull cord looped into each end of a slider and its route around transverse rods end rollers.

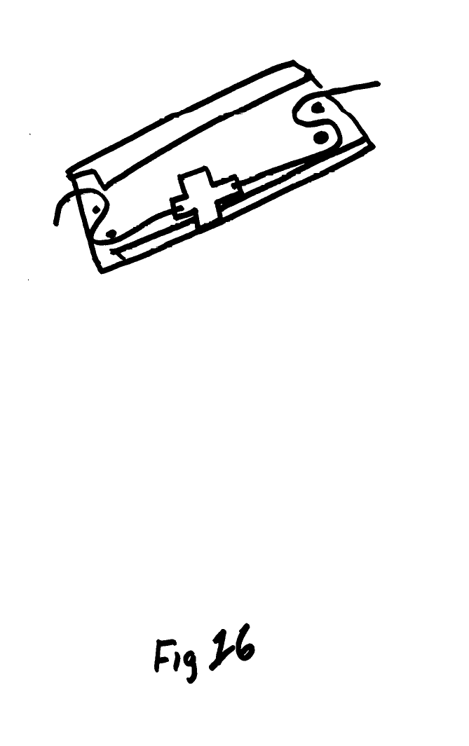

FIG. 17—Shows nipples landing base.

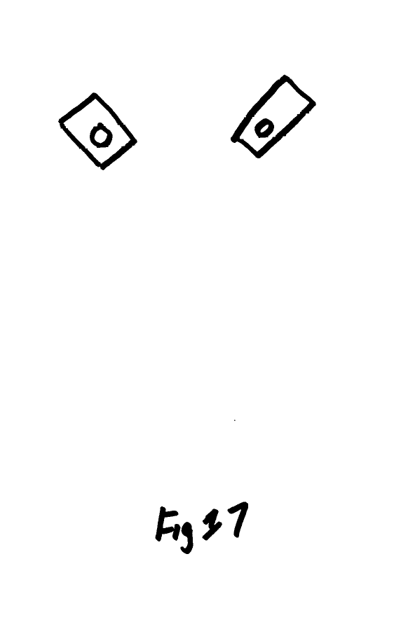

FIG. 18—Shows nipples landing base inside a side post.

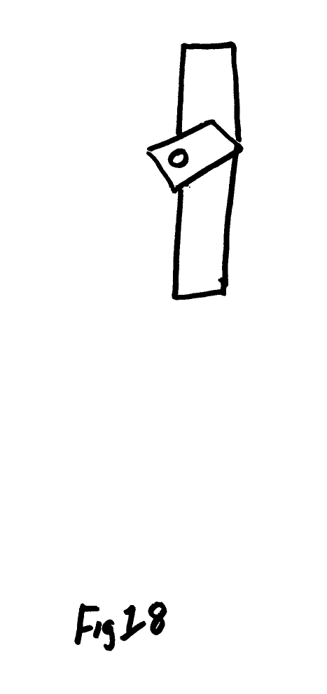

FIG. 19—Shows two, two-piece side posts.

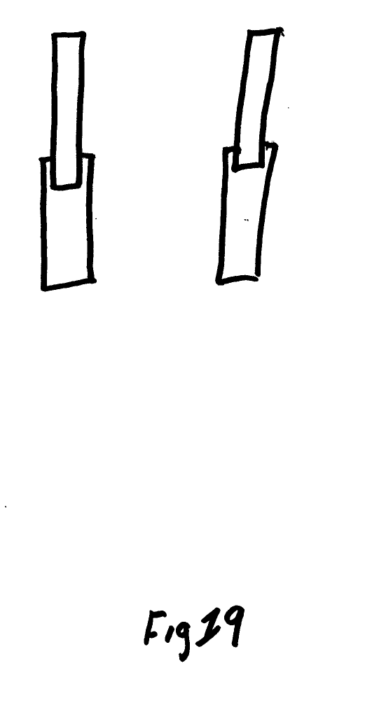

FIG. 20—Illustrates side posts shaft.

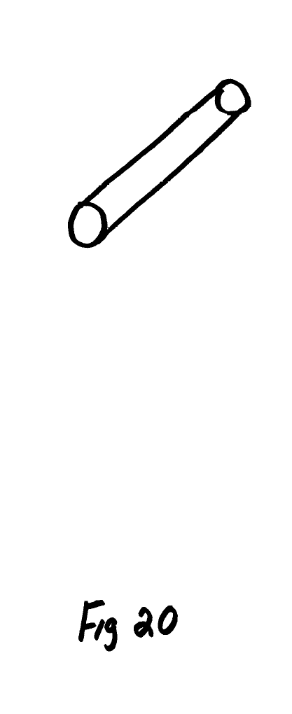

FIG. 21—Illustrates side posts shaft coupling the two-piece side posts

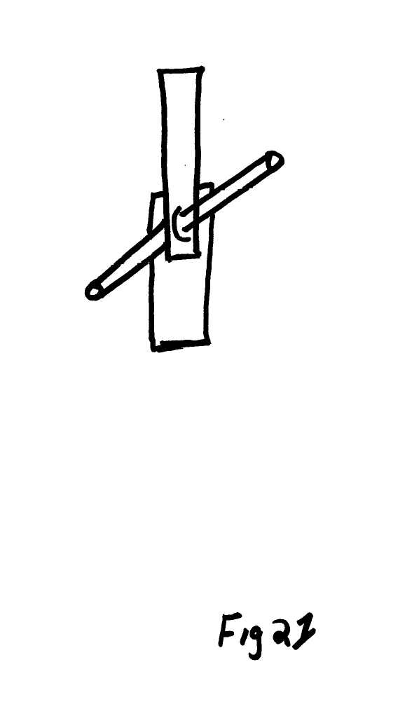

FIG. 22—Shows one of a plurality of transverse rods end nipples locked into a side posts landing base.

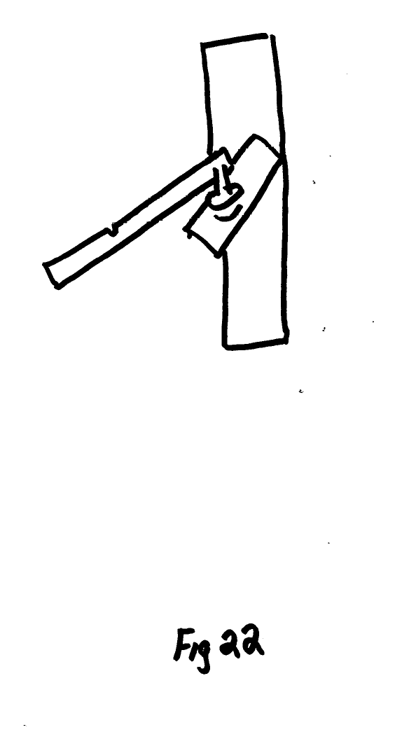

W claim:

1. Originality to a method of embarking and disembarking children into and out of a vehicle in need of sitting in a child seat safely from the sidewalk side of the vehicle regardless of the side of the street the vehicle is parked. Thereby limiting danger to both the child and the assisting adult by means of a child seat carrying carriage. Configured to be used thought not limited to the rear seat of a vehicle.
Further configured to be removable and when in use secured to the vehicle's seat, child seat and the child in need of securement.
A child seat carrying carriage that moves horizontally within a vehicle along the longitude of a plurality of transverse rods serving as support of said carriage.
In one embodiment there may be the use of two (2) transverse rods, in another the use of five (5) transverse rods.
Furthermore, side posts support and balance transverse rods and carriage.

2. Transverse rod(s) of claims 1, comprise of two straps wherein the straps of the upper foremost said transverse rod secures to the vehicle seats' headrest.

3. Transverse rods(s) of claims 1, further comprise of safety self-locking slits/openings, wherein said carriage drops into lower portion of said transverse rods(s) locking said carriage into safety mode by means of sliders.

4. Transverse rod(s) of claims 1, further comprise of rollers at each end, a plurality of end rollers support and keep a pull cord on track.

5. Pull cord of claims 4, wherein the pull cord is routed within said transverse rod(s) interior and loops around the plurality of said end rollers, while tied to each side of slider(s).
Said pull cord may be pulled via one transverse rod or throughout a plurality of transvers rods.

6. Sliders of claims 3, wherein said pull cord ties to each slider(s), when pulled, said slider moves right or left carrying said carriage into selected direction. Said slider may be used throughout the plurality of said transverse rods.

7. Sliders of claims 3, further comprise of receptacle tubes, wherein, they mate with penetrating tubes.

8. Though not shown, lateral movement of said carriage and sliders can be accomplished by remote control, said pull cord and or pull straps.

9. Penetrating tubes of claims 7, comprise of a back plate attached to carriage backrest. Said penetrating tubes extend from the back plate and insert into said receptacle tube attached to said transverse rods.

10. Transvers rods of claims 1, further comprise in some embodiments of an extension to be attached to transverse rod ends to suit the width of a vehicle's interior.

11. Transverse rods of claims 1, further comprise of end nipples.

12. End nipples of transverse rods' ends lock into safety onto landing bases.

13. Landing bases of claims 12, wherein, on side posts lock said nipples into safety and stability.

14. Side posts of claims 1, wherein such stabilize movement of transverse rods while supporting and balancing said transverse rods and said carriage.

15. Side posts of claims 1, further comprise of a shaft.

16. Shafts of claims 15, wherein such support the two piece said side posts. Shafts allow the two-piece side posts to pivot into a closed and open position, while keeping both pieces joined together.

17. Carriage of claims 1, comprise an overhead strap, wherein said strap extends from the carriage upper backrest and around vehicle seat(s) headrests.

18. Carriage of claims 1, further comprise of backrest straps.

19. Backrest of claims 18, wherein on each side of said carriage backrest are pulled towards desired side of a vehicle.

20. Backrest of claims 18, further comprise of wheels, wherein, at the lower portion of said backrest assist in the smooth transition of said carriage over the vehicles' seats.

21. Carriage of claims 1, further comprise of a base.

22. Base of claims 21, comprise of a seatbelt, wherein, it secures the child in a child seat.

23. Base of claims 21, further comprise of pull straps, wherein, on each side of the base in conjunction with said carriage backrest straps allow said carriage to be pulled as a whole.

24. Base of claims 21, further comprise of a frontal strap wherein, it wraps around the front portion of the vehicles' seat.

25. Carriage of claims 1, further comprise of hinges, wherein, each side of the carriage lock the carriage backrest and base into an open L-shape position.

26. Carriage of claims 1, further comprise of a shaft, wherein, at the bottom of carriage said backrest and the rear of carriage base allows both to pivot against and away from each other.
